(19) United States
(12) Patent Application Publication
(10) Pub. No.: US 2023/0146784 A1
(43) Pub. Date: May 11, 2023

(54) COMPACT CLINICAL DIAGNOSTICS SYSTEM WITH PLANAR SAMPLE TRANSPORT

(71) Applicant: Siemens Healthcare Diagnostics Inc., Tarrytown, NY (US)

(72) Inventors: Tim Use, Nürnberg (DE); Christoph Loetzsch, Eggolsheim (DE)

(73) Assignee: Siemens Healthcare Diagnostics Inc., Tarrytown, NY (US)

(21) Appl. No.: 17/906,554

(22) PCT Filed: Mar. 16, 2021
(86) PCT No.: PCT/US21/22636

§ 371 Date: Sep. 16, 2022

Related U.S. Application Data
(60) Provisional application No. 62/990,684, filed on Mar. 17, 2020.

(51) Int. Cl. G01N 35/04; G01N 35/00

(52) U.S. Cl. CPC G01N 35/04; G01N 35/0099; G01N 2035/0477; G01N 2035/0491; G01N 2035/0418

(57) ABSTRACT

A clinical diagnostics system provides at least one biochemical analyzer and a track with one or more carriers for clinical samples, wherein the track and carriers are configured to effect carrier motion in a horizontal plane and the biochemical analyzer is arranged above the track and the one or more carriers.

### CROSS REFERENCE TO RELATED APPLICATION

This application claims the benefit of U.S. Provisional Patent Application No. 62/990,684, entitled “COMPACT CLINICAL DIAGNOSTICS SYSTEM WITH PLANAR SAMPLE TRANSPORT” filed Mar. 17, 2020, the disclosure of which is hereby incorporated by reference in its entirety for all purposes.

### TECHNOLOGY FIELD

The present invention pertains to a clinical diagnostics system comprising one or more analyzers and a track with one or more carriers, wherein the track and carriers are configured to effect carrier motion in a horizontal plane.

### BACKGROUND

Clinical diagnostics systems comprising a track for transportation of sample containers along a preset path in a horizontal plane are known in the prior art. Usually the preset path is single tracked and the samples move usually only in one direction.

U.S. Pat. No. 9,239,335 B2 pertains to a laboratory sample distribution system comprising a plurality of sample container carriers that each include at least one permanent magnet. A plurality of stationary electro-magnetic actuators are arranged below a transport plane. The electro-magnetic actuators move a container carrier along the transport plane by applying a magnetic force to the sample container carrier. The system further comprises at least one transfer device for transferring a sample container carrier, a sample container, or a sample between the transport plane and an analysis station.

Automated clinical diagnostics systems have improved the versatility, scope, and affordability of medical testing. In order to cope with a continually expanding demand for medical testing, the efficiency of clinical diagnostics systems needs to be improved.

### SUMMARY

In a first embodiment, a clinical diagnostics system comprises one or more analyzers and a track with one or more carriers, wherein the track and carriers are configured to effect carrier motion in a horizontal plane and the at least one analyzer is arranged above the track and the one or more carriers. The carriers can be moved more or less freely in the horizontal plane without being limited to a single tracked system or moving on the track in only one direction.

In a second embodiment, a method for automated biochemical analysis comprises the steps of:
(a) providing a clinical diagnostics system comprising one or more analyzers and a track with one or more carriers, wherein the track and carriers are configured to effect carrier motion in a horizontal plane and the at least one analyzer is arranged above the track and the one or more carriers;
(b) disposing one or more containers with clinical samples on the at least one carrier;
(c) registering the position and orientation of the at least one container relative to the clinical diagnostics system;
(d) moving the carrier to a position wherein the at least one container is arranged underneath the analyzer;
(e) transferring clinical sample to the analyzer; and
(f) performing biochemical analysis of the clinical sample.

### BRIEF DESCRIPTION OF THE DRAWINGS

FIG. 1 depicts a schematic side view of a clinical diagnostics system comprising carriers for sample containers that are moved in a horizontal plane above a track.

FIG. 2 illustrates a clinical diagnostics system with multiple sample carriers on a track arranged below an analyzer.

FIGS. 3A and 3B show perspective and telecentric plan views of a carrier and a thereon disposed rack with sample containers.

FIGS. 4A-4D illustrate the alignment of a misplaced rack with sample containers relative to a carrier using a mechanical aligner.

### DETAILED DESCRIPTION

The present invention has an object to provide a clinical diagnostics system that affords high sample throughput in conjunction with reduced footprint and complexity.

This object is achieved by a clinical diagnostics system comprising one or more analyzers and a track with one or more carriers, wherein the track and carriers are configured to effect carrier motion in a horizontal plane and the at least one analyzer is arranged above the track and the one or more carriers.

Expedient embodiments of the invention are characterized in that:
the clinical diagnostics system comprises an electronic automation system;
the electronic automation system comprises one or more digital processors;
the electronic automation system comprises electronic memory;
the electronic automation system comprises an electronically stored automation program;
the electronic automation system comprises an electronic carrier motion control system configured to detect the position of each of the one or more carriers;
the electronic automation control system is configured for workflow prioritization;
the electronic automation control system is configured for workflow optimization;
the automation control program comprises an artificial neural network trained for workflow optimization using workflow data collected during operation of an installed base of clinical diagnostics systems;
the automation control program comprises an artificial neural network trained for workflow optimization using workflow data generated by Monte-Carlo simulation of a clinical diagnostics system;
the clinical diagnostics system comprises one or more loaders;
the clinical diagnostics system comprises one or more supply stations for biochemical reagents;
one or more loaders are arranged above the track and the one or more carriers;
one or more supply stations are arranged above the track and the one or more carriers;
a minimal vertical clearance between an upper track surface and a lower static part of the at least one analyzer, loader or supply station is 50 mm, 100 mm, 150 mm, 200 mm, 250 mm or 300 mm;
a reference coordinate system of the clinical diagnostics system has coordinate axes \hat{x}=(1,0,0), ŷ=(0,1,0) and \hat{z}=(0,0,1);
a reference coordinate system of the clinical diagnostics system has coordinate axes \hat{x}=(1,0,0), ŷ=(0,1,0) and \hat{z}=(0,0,1) wherein coordinate axis \hat{z} is parallel to a vertical direction;
a reference coordinate system of the clinical diagnostics system has origin vector \vec{O}=(0,0,0);
a reference coordinate system of the clinical diagnostics system is calibrated in meter, millimeter, micrometer or inch units;
the track has an upper surface that is substantially parallel to a plane spanned by reference coordinate axes \hat{x} and ŷ;
the track has an upper surface normal vector \hat{t} with \hat{t}·\hat{t}=1 that is substantially parallel to coordinate axis \hat{z}, such that 0.995≤|\hat{t}·\hat{z}|≤1;
the track and carrier are configured to effect carrier motion and positioning at select continuous positions within a horizontal plane above the upper track surface;
the track and carrier are configured to effect carrier motion and positioning at select continuous positions within a horizontal plane having normal vector ĥ with ĥ·ĥ=1 that is substantially parallel to coordinate axis \hat{z}, such that 0.995≤|ĥ·\hat{z}≤1; the track is comprised of one or more track modules;
the track is comprised of tiled track modules;
the track is comprised of tiled track modules with seamlessly joined upper surfaces;
the track is comprised of one or more track modules having an upper surface with rectangular, equilateral triangular or equilateral hexagonal shape;
an upper track surface covers a connected area composed of rectangles, equilateral triangles or equilateral hexagons;
an upper track surface covers a simply, dual, triple or multiply connected area;
the track and carrier are configured to effect carrier positioning with a lateral precision of ≤1000 μm, ≤100 μm, ≤10 μm or ×2 μm;
the track and carrier are configured to effect carrier positioning with a lateral repeatability of ≤1000 μm, ≤100 μm, ≤10 μm or ≤2 μm;
the track and carrier are configured to effect carrier rotation about a vertical axis;
the track and carrier are configured to effect carrier rotation about an axis ŝ with ŝ·ŝ=1 that is substantially parallel to reference coordinate axis \hat{z}, such that 0.995≤ŝ·\hat{z}|≤1;
the track and carrier are configured to effect carrier rotation about a vertical axis by a select continuous rotation angle;
the track and carrier are configured to effect carrier rotation about an axis ŝ with ŝ·ŝ=1 that is substantially parallel to reference coordinate axis \hat{z}, such that 0.995≤|ŝ·\hat{z}|≤1 by a select continuous rotation angle;
the track and carrier are configured to effect magnetic carrier levitation above an upper surface of the track;
the track and carrier are configured to effect magnetic carrier levitation above an upper surface of the track with a vertical clearance D with 0.5 mm≤D≤10 mm;
the track and carrier are configured to effect magnetic carrier levitation above an upper surface of the track with an air gap clearance D with 0.5 mm≤D≤10 mm;
the track and carrier are configured to effect magnetic levitation and motion of the carrier in a horizontal plane above an upper surface of the track;
the track and carrier are configured to determine the weight of a carrier;
the track and carrier are configured to measure the weight of a carrier and determine whether the carrier is empty or carries a payload;
the track is configured to generate a constant or modulated magnetic field;
the track is configured to generate a time- and/or space-modulated magnetic field;
the track is configured to generate a time- and/or space-modulated magnetic field and thereby exert a horizontally directed magnetic force on one or more carriers;
the track comprises a plurality of electromagnetic inductors;
the track comprises a plurality of electromagnetic coils;
the track comprises a plurality of magnetic field sensors;
the track comprises a plurality of Hall sensors;
the track comprises an electric adapter configured for supplying each of the plurality of electromagnetic inductors with electric power from an external source;
the track comprises an electric adapter configured for supplying each of the plurality of electromagnetic coils with electric power from an external source;
the track comprises an electronic carrier motion control system configured to modulate an electric current in each of the plurality of electromagnetic inductors;
the track comprises an electronic carrier motion control system configured to modulate an electric current in each of the plurality of electromagnetic coils;
each magnetic field sensor is electrically connected to the electronic carrier motion control system;
the output of each magnetic field sensor is electrically connected to the electronic carrier motion control system;
the electronic carrier motion control system comprises a digital processor;
the electronic carrier motion control system comprises electronic memory;
the electronic carrier motion control system is configured to detect the position of each of the one or more carriers based on the output signals of the plurality of magnetic field sensors;
the electronic carrier motion control system is configured to detect the position of each of the one or more carriers with a lateral precision of ≤1000 μm, ≤100 μm, ≤10 μm or ≤2 μm;
the electronic carrier motion control system comprises an electronically stored motion control program configured for carrier routing;
the electronic carrier motion control system is configured to prevent carrier collision;
the electronic carrier motion control system is configured for optimization of carrier routing;
the electronic carrier motion control system is configured to determine the weight of a carrier;
the electronic carrier motion control system is configured to measure the weight of a carrier and determine whether the carrier is empty or carries a payload;
each carrier comprises one or more permanent magnets;
each carrier comprises one or more permanent magnet assemblies;
each carrier comprises one or more Halbach arrays;
each carrier comprises four rectangular Halbach arrays;
at least one of an analyzer, a loader or a supply station comprises a track and an actuator configured to effect actuator motion and positioning at select continuous positions within a plane having a normal vector ĥ substantially perpendicular to a vertical direction;
at least one of an analyzer, a loader or a supply station comprises a track and an actuator, such as robotic pipettor or robotic handler configured to effect actuator motion and positioning at select continuous positions within a plane having a normal vector ĥ substantially perpendicular to a vertical direction;
at least one of an analyzer, a loader or a supply station comprises a track and an actuator configured to effect actuator motion and positioning at select continuous positions within a plane having a normal vector ĥ with ĥ·ĥ=1 substantially perpendicular to a vertical direction such that |ĥ·\hat{z}|≤0.09;
at least one of an analyzer, a loader or a supply station comprises a track and an actuator configured to effect magnetic levitation and motion of the actuator in a plane having a normal vector ĥ substantially perpendicular to a vertical direction;
at least one carrier comprises one or more optical alignment marks;
at least one carrier comprises one or more optical alignment marks comprising one or more patterns shaped as rectangular stripe, cross or circle;
at least one carrier comprises a cover plate made from a polymeric material, metal, glass or ceramic;
at least one carrier comprises a coating film made from a polymeric material, metal or ceramic;
an upper surface of at least one carrier is equipped with one or more convex protrusions for mechanical alignment of a rack for holding sample or reactant containers;
an upper surface of at least one carrier is equipped with one or more convex protrusions having a conical or cylindrical shape for mechanical alignment of a rack having a lower surface equipped with one or more thereto form-fitting recesses;
one or more carriers are equipped with a rack configured for holding one, two, three or more containers for clinical sample fluids and/or biochemical reactant fluids;
each rack comprises one, two three or more recesses;
each rack comprises one, two three or more recesses wherein each recess is equipped with one, two or three springs for clamping of containers;
each rack comprises one, two three or more recesses with rectangular or cylindrical shape;
each rack comprises 1 to 40, 1 to 30, 1 to 20 or 1 to 10 recesses for retention of containers;
the at least one loader comprises a robotic handler configured for pick and place handling of a rack from, respectively onto a carrier;
the at least one loader comprises a robotic handler configured for pick and place handling of containers from, respectively into a rack arranged on a carrier;
the at least one analyzer comprises a robotic handler configured for pick and place handling of containers from, respectively into a rack arranged on a carrier;
the at least one analyzer comprises a robotic pipette system configured for aspiring and dispensing fluids from, respectively into containers retained in a rack arranged on a carrier;
the at least one analyzer comprises a robotic handler configured for pick and place handling of reagent vessels from, respectively onto a carrier;
the at least one analyzer comprises a robotic pipettor configured for aspiring fluids from reagent vessels arranged on a carrier;
the robotic pipettor comprises one linear actuator configured for pipette motion along an axis â with â·â=1 that is substantially parallel to reference coordinate axis z, such that 0.995≤â·\hat{z}|≤1;
the robotic pipettor is configured for pipette tilting such that an angle ϑ between a pipette tube center axis and reference coordinate axis \hat{z} is adjusted from 0 to 10 degrees, i.e. 0°≤ϑ≤10°;
the robotic pipettor comprises a tripod tilt actuator configured for pipette tilting such that an angle ϑ between a pipette tube center axis and reference coordinate axis \hat{z} is adjusted from 0 to 10 degrees, i.e. 0°≤ϑ≤10°;
the at least one supply station comprises a robotic handler configured for pick and place handling of reagent vessels from, respectively onto a carrier;
the clinical diagnostics system comprises at least one digital vision system;
the digital vision system and the electronic carrier motion control system are configured for registration and real-time positioning of an object disposed on a carrier relative to the clinical diagnostics system;
the digital vision system and the electronic carrier motion control system are configured for registration and real-time positioning of an object disposed on a carrier relative to a reference coordinate system of the clinical diagnostics system;
the digital vision system and the electronic carrier motion control system are configured for registration of an object disposed on a carrier relative to the carrier;
the digital vision system and the electronic carrier motion control system are configured for registration of an object disposed on a carrier relative to a coordinate system of the carrier;
the clinical diagnostics system comprises a mechanical aligner;
the clinical diagnostics system comprises a mechanical aligner configured for alignment of an object disposed on a carrier using the digital vision system in conjunction with controlled carrier motion;
the digital vision system and the mechanical aligner are configured for alignment of a rack relative to a carrier;
the mechanical aligner is configured to retain a rack in position while a carrier supporting the rack is translated in a horizontal plane;
the mechanical aligner is configured to retain a rack in position while a carrier supporting the rack is rotated about a vertical axis;
the mechanical aligner comprises a recess having an inner surface that is congruent to a surface contour of a rack;
the mechanical aligner comprises a recess having a rectangular shape and each rack comprises four or more vertically oriented edges with rectangular shape;
the digital vision system comprises one, two, three or more digital cameras;
one, two, three or more digital cameras of the digital vision system are equipped with a telecentric objective;
one, two, three or more digital cameras of the digital vision system are equipped with a telecentric objective having a field of view of ≥30 mm, ≥40 mm, ≥50 mm, ≥60 mm, ≥70 mm, ≥80 mm, ≥90 mm, ≥100 mm, ≥110 mm ≥120 mm, ≥130 mm or ≥140 mm in at least one direction;
the digital vision system comprises two digital cameras each equipped with a telecentric objective;
the digital vision system comprises three digital cameras each equipped with a telecentric objective;
the digital vision system and the track and carriers are configured to acquire digital images of a carrier with a thereon disposed rack holding containers via linear or rotary scanning;
one, two, three or more digital cameras of the digital vision system are configured as scanning camera comprising a regular (perspective) or telecentric objective and an optoelectronic image sensor comprised of 1 to 64 sensor rows;
one, two, three or more digital cameras of the digital vision system are configured as scanning camera comprising a regular (perspective) or telecentric objective and an optoelectronic image sensor comprised of 1 to 64 sensor rows each composed of 4 k to 32 k (i.e. 4×1024 to 32×1024) active pixels;
one, two, three or more digital cameras of the digital vision system are configured as lightfield camera and comprise a multi lens array arranged between an electronic image sensor and an objective of the camera;
the digital vision system comprises two or three digital cameras, wherein the optical axes of the two or three digital cameras are oriented substantially perpendicular to each other;
the digital vision system comprises a digital camera having an optical axis \hat{λ} with \hat{λ}·\hat{λ}=1 oriented substantially parallel to reference coordinate axis \hat{x}, such that 0.995≤|\hat{Δ}·\hat{x}|≤1;
the digital vision system comprises a digital camera having an optical axis \hat{μ} with \hat{μ}·\hat{μ}=1 oriented substantially parallel to reference coordinate axis ŷ, such that 0.995≤|\hat{μ}·\hat{x}|≤1;
the digital vision system comprises a digital camera having an optical axis \hat{v} with \hat{v}·\hat{v}=1 oriented substantially parallel to reference coordinate axis \hat{z}, such that 0.995≤|\hat{v}·\hat{x}|≤1;
the digital vision system comprises one, two, three or more light sources each configured for collimated backlighting directed towards one digital camera of one, two, three or more digital cameras;
the digital vision system comprises one, two, three or more light sources each configured for collimated brightfield illumination directed along the optical axis of one digital camera of one, two, three or more digital cameras;
the digital vision system comprises at least one semitransparent mirror or beam splitter configured for reflection of a collimated light source for brightfield illumination along the optical axis of one digital camera of one, two, three or more digital cameras;
the digital vision system comprises a digital processor and electronic memory;
the digital vision system comprises an electronically stored program;
the digital vision system is configured for image analysis;
the digital vision system is configured for object recognition;
the digital vision system is configured for determining the position of an object in the reference coordinate system of the clinical diagnostics system;
the digital vision system is configured for determining the orientation of an object in the reference coordinate system of the clinical diagnostics system;
the digital vision system is configured for determining an optical outline of an object;
the digital vision system is configured for determining the dimensions of an optical outline of an object;
the digital vision system is configured for determining the dimensions of a first optical outline of an object in a first plane with normal vector \hat{p} with \hat{p}·\hat{p}=1 substantially perpendicular to reference coordinate axis \hat{z} such that |\hat{p}·\hat{z}|≤0.09;
the digital vision system is configured for determining the dimensions of a second optical outline of an object in a second plane with normal vector \hat{q} with \hat{q}·\hat{q}=1 substantially perpendicular to reference coordinate axis \hat{z} such that |\hat{q}·\hat{z}|≤0.09;
the digital vision system is configured for determining the dimensions of a first optical outline of an object in a first plane with normal vector \hat{p} with \hat{p}·\hat{p}=1 and the dimensions of a second optical outline of the object in a second plane with normal vector \hat{q} with \hat{q}·\hat{q}=1 wherein \hat{p} and \hat{q} are substantially perpendicular to each other, such that |\hat{p}·\hat{q}|≤0.09, and substantially perpendicular to reference coordinate axis \hat{z} such that |\hat{p}·\hat{z}|≤0.09 and |\hat{q}·\hat{z}|≤0.09;
the digital vision system is configured for determining the dimensions of an optical outline of an object in a plane with normal vector \hat{p} with \hat{p}·\hat{p}=1 substantially parallel to reference coordinate axis \hat{x} such that 0.995≤|\hat{p}·\hat{x}|≤1;
the digital vision system is configured for determining the dimensions of an optical outline of an object in a plane with normal vector \hat{q} with \hat{q}·\hat{q}=1 substantially parallel to reference coordinate axis ŷ such that 0.995≤|\hat{q}·ŷ|≤1; and/or
the digital vision system is configured for determining the dimensions of an optical outline of an object in a plane with normal vector \hat{v} with \hat{v}·\hat{v}=1 substantially parallel to reference coordinate axis \hat{z} such that 0.995≤|\hat{v}·\hat{z}|≤1.

The present invention is further aiming at a flexible and efficient method for automated biochemical analysis of clinical samples. In particular, the method shall accommodate analyses that deviate from standard work processes and samples that are manually or automatically conveyed.

This object is achieved by a method for automated biochemical analysis comprising the steps of:
(a) providing a clinical diagnostics system comprising one or more analyzers and a track with one or more carriers, wherein the track and carriers are configured to effect carrier motion in a horizontal plane and the at least one analyzer is arranged above the track and the one or more carriers;
(b) disposing one or more containers with clinical samples on the at least one carrier;
(c) registering the position and orientation of the at least one container relative to the clinical diagnostics system;
(d) moving the carrier to a position wherein the at least one container is arranged underneath the analyzer;
(e) transferring clinical sample to the analyzer; and
(f) performing biochemical analysis of the clinical sample.

Expedient embodiments of the inventive method are characterized in that:
one or more sample containers are held in a rack and the rack is disposed on a carrier;
in step (c) one, two or more digital images of the carrier and container are acquired and processed using a digital vision system;
in step (c) one, two or more digital images of the carrier, rack and container are acquired and processed using a digital vision system;
in step (c) the carrier and container are imaged using one, two, three or more digital cameras wherein at least one digital camera is equipped with a telecentric objective;
in step (c) the carrier, rack and container are imaged using one, two, three or more digital cameras wherein at least one digital camera is equipped with a telecentric objective;
in step (c) relative or absolute dimensions of the carrier and container are determined;
in step (c) relative or absolute dimensions of the carrier, rack and container are determined;
in step (c) a rack supported by a carrier in an off-center position is aligned relative to the carrier;
in step (c) a rack supported by a carrier in an off-center position is aligned relative to the carrier using a mechanical aligner and the digital vision system;
in step (c) a rack is retained in position by a mechanical aligner while a carrier supporting the rack is moved in a horizontal plane;
in step (c) a rack is retained in position by a mechanical aligner while a carrier supporting the rack is rotated about a vertical axis;
in steps (d), (e) and (f) the position of the at least one container is monitored in real-time;
at least one carrier is magnetically levitated and moved in a horizontal plane above an upper surface of the track;
in step (e) a pipette is lowered along a direction that is substantially parallel to a vertical axis, immersed into the clinical sample and a portion of the sample is aspired and transferred to the analyzer;
the clinical diagnostics systems comprises an electronic automation control system that optimizes the workflow of sample analyses;
the workflow of biochemical analyses is optimized by an electronic automation control system forming part of the clinical diagnostics system;
at least one sample is assigned a priority and said priority is input to and processed by the electronic automation control system;
the automation control system employs an artificial neural network trained for workflow optimization using workflow data collected during operation of an installed base of clinical diagnostics systems; and/or
the automation control system employs an artificial neural network trained for workflow optimization using workflow data generated by Monte-Carlo simulation of a clinical diagnostics system.

The inventive clinical analyzer comprises a plurality of components, i.e., physical objects, which—based on their function—may be assigned to an object class. Pursuant to the paradigm of object-oriented programming, each physical object may be represented as a digital data object stored in an electronic automation or control system. A list of the object classes and corresponding physical objects and data objects is shown beneath in Table 1.

TABLE 1
Object classes and pertinent physical objects and data objects

| Object class | Physical object | Data object |
|---|---|---|
| track class | track (1^{st} track, 2^{nd} track, . . .) | track data object |
| carrier class | carrier (1^{st} carrier, 2^{nd} carrier, . . .) | carrier data object |
| rack class | rack (1^{st} rack, 2^{nd} rack, . . .) | rack data object |
| container class | container (1^{st} container, 2^{nd} container, . . .) | container data object |
| loader class | loader (1^{st} loader, 2^{nd} loader, . . .) | loader data object |
| analyzer class | analyzer (1^{st} analyzer, 2^{nd} analyzer, . . .) | analyzer data object |
| supply station class | supply station (1^{st} supply station, | supply station data |
| | 2^{nd} supply station, . . .) | object |

The object-oriented schema presented in Table 1 illustrates a preferred programming and data management technique for motion control and registration. However, it is emphasized that the inventive diagnostics system may employ alternative programming and data management techniques that do not embody the object-oriented programming paradigm.

The inventive diagnostics system may employ one or more physical and one or more corresponding data objects of each object class. Different physical objects of the same class are designated with prefixes “first,” “second,” “third,” and so forth, e.g. first carrier, second carrier, third carrier, etc.

Each data object comprises a unique identifier, which may be comprised of numbers and characters, a coordinate origin vector, and three coordinates axes. The coordinate origin vector and the three coordinate axes are each represented by a three-dimensional vector, i.e., an array of three real numbers. The three coordinate axes are linearly independent and preferably form a set of three orthonormal vectors \vec{e}ᵢ with i=1, 2 or 3 and \vec{e}ᵢ·\vec{e}ⱼ=δᵢⱼ wherein the Kronecker symbol δᵢⱼ equals 1 for i=j and 0 for i≠j. Without loss of generality, the coordinate origin vector may preferably be represented by an array of three Zeros, i.e., (0,0,0).

Each data object furthermore comprises a three-dimensional translation vector \vec{t} and an orthogonal rotation matrix \hat{R} with three rows and three columns, i.e., an orthogonal two-dimensional 3×3 matrix. The position and orientation of each physical object relative to a global reference coordinate system is fully characterized by translation vector \vec{t} and rotation matrix \hat{R}, such that a location represented by a vector \vec{p} in the object coordinate system corresponds to a location represented by vector \vec{P}=\hat{R}·\vec{p}+\vec{t} in the reference coordinate system.

Preferably, without loss of generality, the reference origin vector and the three reference coordinate axes are represented by vectors \vec{O}=(0,0,0) and \hat{x}=(1,0,0), ŷ=(0,1,0), \hat{z}=(0,0,1), respectively.

Physical objects of the carrier, rack, and container class are mobile, and their location and/or orientation may change with time. Hence, the translation and/or rotation matrix of mobile objects may be time-dependent.

In some instances, such as upon introduction of a rack into a loader, the position and orientation of the respective physical object relative to the reference coordinate system, i.e., the object's translation vector \vec{t} and rotation matrix \hat{R} may be undefined. In such case, translation vector \vec{t} and rotation matrix \hat{R} are determined by means of a mechanical aligner and/or a digital vision system. In the present invention, the process of determining an object's translation vector \vec{t} and rotation matrix \hat{R} is referred to as “registration.”

Generally, physical objects of the track, loader, analyzer, and supply station class are static. Unless expressly stated otherwise, the translation vector \vec{t} and rotation matrix \hat{R} of an object of the track, loader, analyzer, or supply station class are known and fixed.

Without loss of generality, for most physical objects, and particularly for static objects of the track, loader, analyzer, and supply station class, the rotation matrix \hat{R} corresponds to the unit matrix, i.e.,

$$\hat{R} = \hat{1} = ( \begin{matrix}1 & 0 & 0 \\ 0 & 1 & 0 \\ 0 & 0 & 1\end{matrix} )$$

Dynamic objects of the carrier, rack, and container class may be rotated and/or tilted relative to the global reference coordinate system. E.g., each of the three coordinate axes \vec{e}ᵢ of a dynamic object may be described, respectively obtained by rotation of one of three reference coordinate axes \hat{x}=(1,0,0), ŷ=(0,1,0), \hat{z}=(0,0,1) around a rotation axis ŵ by an angle ω. The coefficients of the corresponding rotation matrix \hat{R}(ŵ|ω) are described by the formula

[\hat{R}(ŵ|ω)]ᵢⱼ=[1−cos ω]·ŵᵢ·ŵⱼ+cos ω·δᵢⱼ+sin ω·εᵢₖⱼ·ŵₖ

wherein ŵ is the rotation axis unit vector with ŵ·ŵ=1 and δᵢⱼ and εᵢₖⱼ designate the Kronecker and Livi-Civita symbol, respectively (https://en.wikipedia.org/wiki/Rotation_matrix; https://en.wikipedia.org/wiki/Kronecker_delta; https://en.wikipedia.org/wiki/Levi-Civita_symbol).

For most practical cases, however, the rotation axis ŵ of dynamic objects is substantially parallel to reference coordinate axis \hat{z} such that 0.995≤|ŵ·\hat{z}|≤1 and

$$\hat{R} ( \hat{w} \vert ω ) \approx ( \begin{matrix}cos ω & - sin ω & 0 \\ sin ω & cos ω & 0 \\ 0 & 0 & 1\end{matrix} )$$

Each physical object of the loader, analyzer, and supply station class may comprise one or more actuated subcomponents such as a robotic handler or a robotic pipette. Generally, the position and orientation of an actuated subcomponent, e.g., the actuation axis and midpoint between two robotic gripper fingers, or a pipette cylinder axis and pipette tip position, are continuously monitored using one or more conventional encoders. A person skilled in industrial automation is well familiar with, and routinely employs, linear and rotary encoders. Typically, such encoders comprise a capacitive, inductive, magnetic, or optoelectronic sensor, the output of which is electrically connected to a robot control system.

Accordingly, the position and orientation of a subcomponent, such as a robotic handler or robotic pipette in the coordinate system of its parent object, such as an analyzer, is known at any given time and may be converted in real-time to global reference coordinates using the parent objects translation vector \vec{t} and rotation matrix \hat{R}.

The above expounded concepts—some of which are inherent in the art of industrial automation—enable real-time tracking of the position and orientation of each component of the inventive clinical diagnostics system.

The present disclosure employs terms having a specific meaning as hereafter explained:
“motion and positioning at select continuous positions within a horizontal or vertical plane” relates to an electronic actuator system comprising one or more dynamic components and configured to move said components to any selected point within a contiguous area, such as a rectangle within said plane which implies component movement along arbitrarily selectable planar paths;
“real-time” pertains to automated operations that are initiated and/or completed within a few microseconds to a few milliseconds;
“substantially perpendicular” refers to two directions or axes enclosing an angle that deviates by ≤5 degrees from 90 degrees;
“substantially parallel” refers to two directions or axes enclosing an angle of ≤5 degrees;
“arranged above the track and carriers” pertains to an analyzer, a loader, and/or a supply station, a vertical projection of a horizontal cross section thereof onto an upper surface of the track amounts to ≥30%, ≥40%, ≥50%, ≥60%, ≥70%, ≥80% or ≥90% of its total horizontal cross section;
“â·\hat{b}” or “\vec{a}·\vec{b}” designates the scalar product of two vectors, i.e., the sum of component products which in the case of two three-dimensional vectors \vec{a}=(a₁, a₂, a₃) and \vec{b}=(b₁,b₂,b₃) amounts to \vec{a}·\vec{b}=a₁·b₁+a₂·b₂+a₃·b₃.

In a preferred embodiment of the inventive clinical diagnostics system, the digital vision system comprises one, two, or three digital cameras that are equipped with a telecentric objective for proper dimensioning of objects such as racks and containers. Telecentric objectives make objects appear to be the same size independent of their location in space. Telecentric objectives remove the perspective or parallax error that makes closer objects appear larger than objects farther from the camera, increasing measurement accuracy compared to conventional objectives. A skilled person routinely uses telecentric objectives in a variety of applications, including metrology, gauging, CCD based measurement, or microlithography. In many instances, telecentric imaging greatly facilitates computer-based image analysis.

In another expedient embodiment of the inventive clinical diagnostics system, the digital vision system comprises one, two, or three digital lightfield cameras, each equipped with a micro lens array arranged between the camera objective and the image sensor. Digital lightfield cameras such as, e.g., offered by Raytrix® GmbH, enable three dimensional metrology.

The inventive clinical diagnostics system provides various advantages such as small footprint, flexibility, accuracy, speed, fewer mechanical components, reduced maintenance and particle generation.

Continuous sample transport in a horizontal plane with exacting real-time motion control and analyzer disposition above the transport plane allow for a substantial reduction in system complexity, while affording increased flexibility and high throughput.

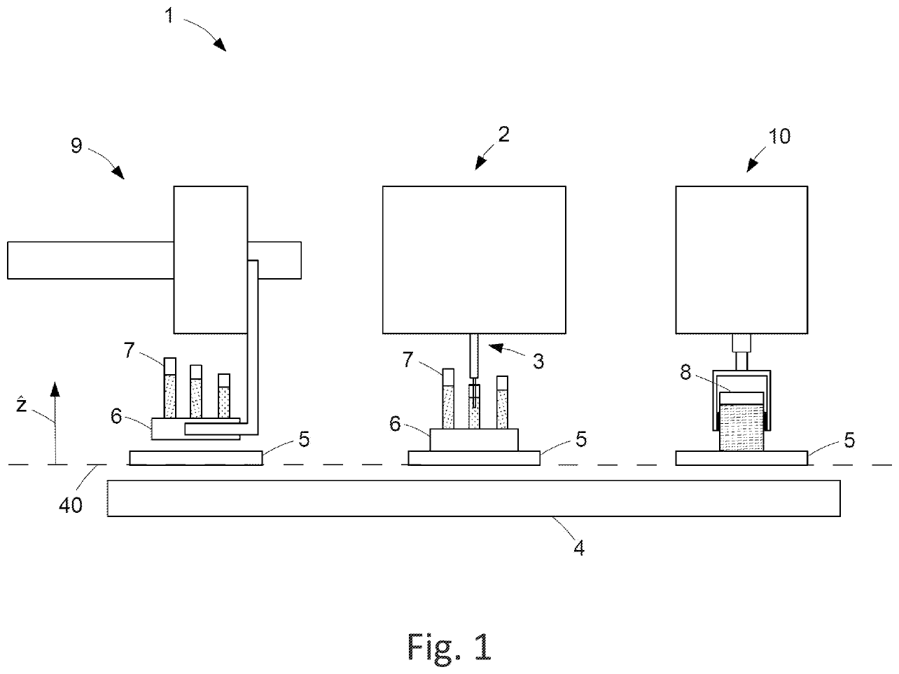

The invention is hereafter further exemplified with reference to FIGS. 1-4.

FIG. 1 shows a schematic side view of a clinical diagnostic system 1 comprising one or more biochemical analyzers 2, a planar track 4, and one or more sample carriers 5. Track 4 and carriers 5 are preferably configured as a magnetic motion system, wherein carriers 5 are magnetically levitated to respectively suspend on a horizontal plane 40 above an upper surface of track 4. Carriers 5 serve as transport vehicles for sample racks 6. One or more of racks 6 are separate units independent from, i.e., unattached to, carriers 5. In an alternative embodiment, one or more of racks 6 are fixated on a carrier 5.

A reference coordinate system with vertical coordinate axis \hat{z}=(0,0,1) is assigned to clinical diagnostics analyzer 1.

Analyzer 2 is arranged above track 4 and carriers 5. A minimal clearance between the upper surface of track 4 and a lower static part of analyzer 2 is ≥5 cm, ≥10 cm, ≥15 cm, ≥20 cm, ≥25 cm, or ≥30 cm. The at least one analyzer 2 comprises one or more robotic pipettors 3 configured for linear vertical motion of a pipette for aspiring and dispensing of sample fluids and biochemical reagent fluids from and into sample containers 7 or a reagent vessel 8. In an expedient embodiment, robotic pipettor 3 is further configured to effect dynamic pipette tilting in order to adapt the trajectory of the pipette, particularly the pipette tip to the cylinder center axis of a coincidentally tilted container 7. Analyzer 2 further houses one or more instruments for spectrophotometry and/or biochemical assays.

Clinical diagnostics system 1 may further comprise one or more loaders 9 and/or one or more supply stations 10. Loader 9 comprises a robotic handler configured for pick and place transfer of sample racks 6 from carriers 5. In addition, or alternatively, a robotic handler of loader 9 may be configured for pick and place handling of individual containers 7 into a rack 6 disposed on a carrier 5. Aside from a gripping actuator, a robotic handler of loader 9 is equipped with one vertical linear motion stage and one or two linear stages for motion in one or two horizontal directions. In yet another embodiment, the robotic handler of loader 9 may include a rotary stage.

Clinical diagnostics system 1 may also comprise one or more supply stations 10 configured for replenishment of biochemical reagents consumed by the at least one analyzer 2. For this purpose, supply station 10 is equipped with a robotic pipettor for transfer of biochemical reagent fluids into reagent vessels 8 and/or a robotic handler for reagent vessels 8. The robotic pipettor and/or robotic handler of supply station 10 comprises at least one linear stage configured for vertical motion aside from—in the latter case—a robotic gripper.

Like analyzer 2, optional loader 9 and optional supply station 10 are preferably arranged above track 4 and carriers 5 such that a vertical projection of a horizontal cross section thereof onto an upper surface of track 4 amounts to ≥30%, ≥40%, ≥50%, ≥60%, ≥70%, ≥80% or ≥90% of its total horizontal cross section. Vertical arrangement of analyzer 2, optional loader 9, and optional supply station 10 above track 4 and carriers 5 considerably reduces the footprint of clinical diagnostics system 1 and economizes expensive laboratory space.

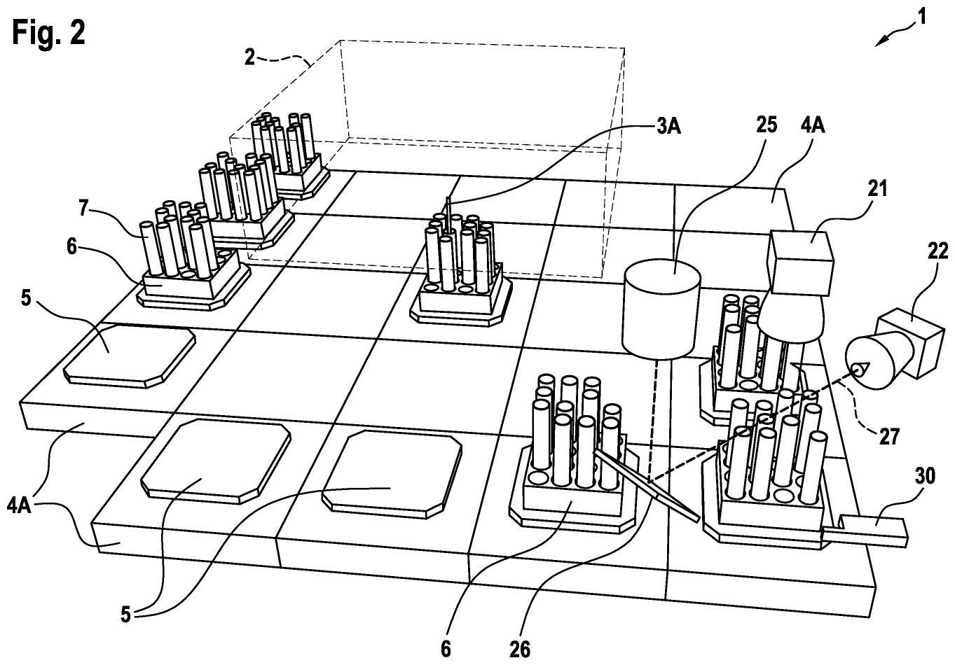

FIG. 2 depicts a perspective view of clinical diagnostics system 1 and illustrates an expedient mode of operation. Clinical diagnostics system 1 comprises a track composed of a plurality of track modules 4A with seamlessly tiled upper surfaces of rectangular, quadratic, equilateral triangular, or equilateral hexagonal shape. The upper surfaces of track modules 4A may form a singly joined area (i.e., without opening) such as shown in FIG. 2. Alternatively, the upper surfaces of track modules 4A may form dual or triple joined areas (i.e., with one or two openings or loops, respectively). The outline of a biochemical analyzer 2 is indicated by dashed lines. Analyzer 2 is arranged above track modules 4A and carriers 5 and comprises one or more robotic pipettors (not shown in FIG. 2) and one or more instruments for spectrophotometry and/or biochemical assays (not shown in FIG. 2). Reference sign 3A indicates a pipette that forms part of a robotic pipettor of analyzer 2, and is inserted in a container 7 held in a rack 6 disposed on a carrier 5 positioned underneath analyzer 2.

A first row of track modules 4A, shown in the foreground of FIG. 2, functions as a load area in which idle carriers 5 are queued. A rack 6 holding containers 7 with newly procured patient samples may be disposed on an idle carrier 5 in the load area either manually by an operator, or by a robotic loader, forming part of clinical diagnostics system 1, or otherwise by an external sample handler.

Depending on queue order or computed priority, a carrier 5 in the load area holding unprocessed samples is moved to a registration area shown in the right-hand side foreground of FIG. 2. Digital cameras 21 and 22 arranged in said registration area form part of a digital vision system. The digital vision system is configured to determine the position of rack 6, and therein held containers 7, relative to carrier 5. Digital cameras 21 and 22 are configured to acquire a plan (i.e., top-down) view and, respectively, side view of carrier 5, rack 6, and containers 7. Preferably, digital cameras 21 and 22 are each equipped with a telecentric objective in order to enable accurate determination of dimensions and relative positions. In an expedient embodiment, the digital vision system further comprises collimated light source 25 in order to improve the quality of digital images acquired with side-view camera 22. The light beam emitted by light source 25 may be redirected using a mirror 26 in order to yield a compact and less obstructive setup.

Advantageously, a series of side-view images are acquired with digital camera 22 at select rotational positions of carrier 5, rack 6, and containers 7. For this purpose, carrier 5 is rotated about a vertical axis by select angular increments. The thereby acquired digital images enable three-dimensional image synthesis and remediation of eventual optical occlusion. Hence, the dimensions, particularly the height of each of containers 7, can be determined.

The plan-view image acquired with digital camera 21 is used to register rack 6 and containers 7 relative to carrier 5, and thereby with the global reference coordinate system.

Carriers 5 with racks 6 holding containers 7 with processed samples, the analysis of which is completed, are queued in an unload area formed by a row of track modules 4A aligned perpendicularly to the load area row as shown on the left-hand side of FIG. 2. Once a rack 6 is removed from a carrier 5 positioned in the unload area, the carrier 5 may be forwarded to the load area, thus, closing the process cycle. Advantageously, the track and carriers are configured to measure the weight of a carrier and assess whether a carrier is empty or carries a payload such as a rack. Accordingly, depending on the availability of space in the load queue, an empty carrier may be automatically advanced from the unload area to the load area.

The above described image-based registration and metrology using plan-view camera 21 and, respectively, side-view camera 22, in conjunction with exacting carrier motion control and positioning and placement of an analyzer above the track, obviate the requirement for robotic pipettors and handlers with multiple linear or rotary axes. E.g., a robotic pipettor of analyzer 2, shown in FIG. 2, merely requires one vertically aligned linear motion stage. Hence, system complexity and maintenance intensity are greatly reduced.

Dimensional calibration (e.g., in meter, millimeter, micrometer, or inch units) may be affected based on known dimensions of either track module 4A, carrier 5, or rack 6. Otherwise, for independent dimensional calibration, standard rulers may be arranged horizontally or vertically aligned on carrier 5 beside rack 6, and jointly imaged using plan-view camera 21 or, respectively, side-view camera 22.

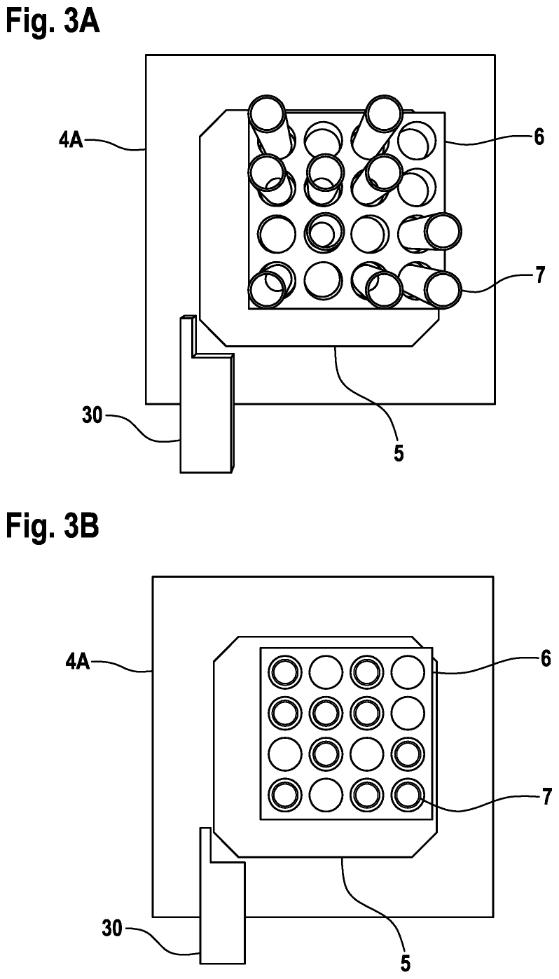

FIGS. 3A and 3B are illustrative of images acquired with digital cameras equipped with a regular (perspective) objective and, respectively, a telecentric objective. FIGS. 3A and 3B show corresponding plan views of a carrier 5 and a thereon disposed rack 6 with sample containers 7, situated (suspended) above a track module 4A. The center of rack 6 is horizontally shifted relative to the center of carrier 5. Off-center placement of rack 6 relative to carrier 5 may be caused by manual or robotic handling errors, the latter of which may be attributable to electronic drift or mechanical wear.

In most instances, rotary misalignment or horizontal shift, such as that shown in FIGS. 3A and 3B, is tolerable and compensated for by proper registration using the digital vision system of the clinical diagnostics system. The digital vision system is configured to infer the position of rack 6 and containers 7 relative to carrier 5, and convert the coordinates (i.e., positions) of rack 6 and containers 7 to global reference coordinates, thus, enabling real-time motion tracking and accurate positioning. As is readily apparent from FIGS. 3A and 3B, telecentric imaging is better suited for digital image-based registration and—as far as needed—dimensional calibration.

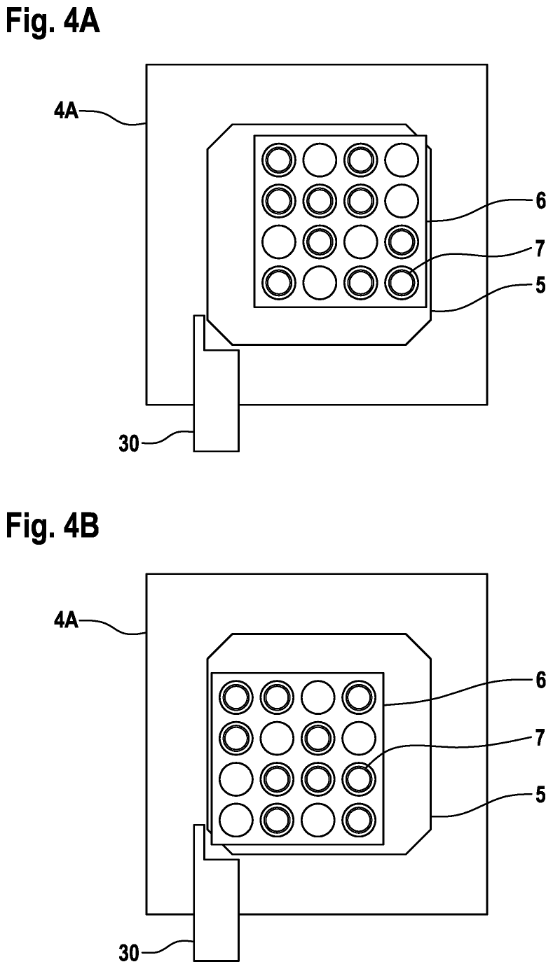

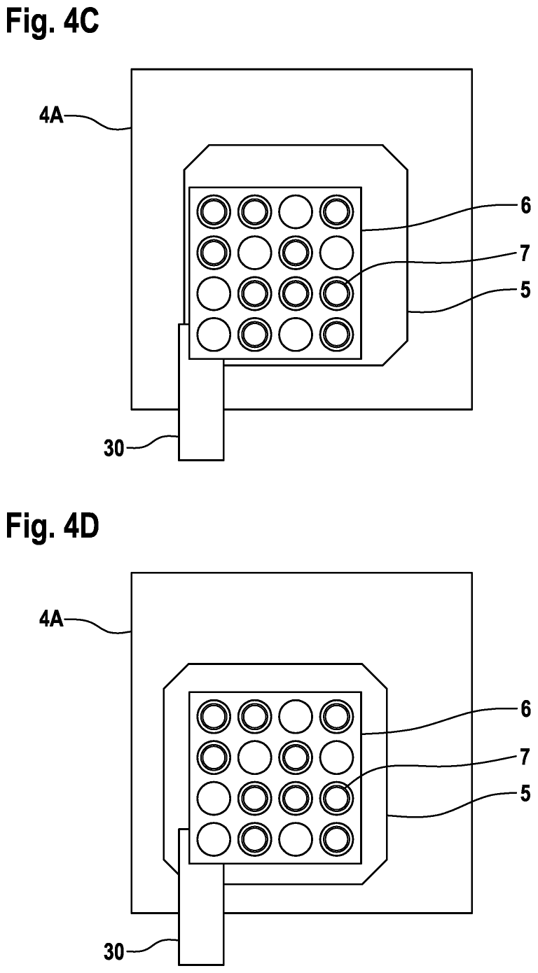

In rare instances, grave misplacement of a rack on a carrier may cause imbalance and tilt, eventually leading to container sling, collision with other objects, or breakage. FIGS. 4A to 4D illustrate how grave rack misplacement may be remedied through mechanical alignment using the digital vision system in conjunction with controlled carrier motion and retention by a mechanical aligner. FIG. 4A is identical to FIG. 3A, and shows rack 6 with containers 7 misplaced relative to carrier 5, which is magnetically suspended above an upper surface of track module 4A. Image-based misplacement detection carrier 5, and thereon disposed rack 6 and containers 7, are rotated by 180 degrees about a vertical axis to the orientation shown in FIG. 4B. Next, carrier 5 is moved along a linear or stepped path that causes a vertical edge of rack 6 to snuggly lodge in a form-fitting rectangular recess of aligner 30, as shown in FIG. 4C. Subsequently, carrier 5 is slid underneath rack 6, retained by aligner 30, to a position wherein rack 6 is centered relative to carrier 5, as depicted in FIG. 4D. Thereafter, rack 6 and therein held containers 7 may be further processed according to the method described above in conjunction with FIG. 2.

### REFERENCE SIGNS

1 . . . clinical diagnostic system
2 . . . analyzer
3 . . . robotic pipettor
3A . . . pipette
4 . . . track
4A . . . track module
5 . . . carrier
6 . . . rack
7 . . . container
8 . . . reagent vessel
9 . . . loader
10 . . . supply station
21 . . . digital camera
22 . . . digital camera
25 . . . light source (preferably collimated)
26 . . . mirror
27 . . . light beam center axis
30 . . . mechanical aligner
40 . . . horizontal plane
\hat{z} . . . vertical reference coordinate axis

We claim:

1. A clinical diagnostics system comprising:
at least one analyzer;
a track; and
a plurality of carriers,
wherein the track and carriers are configured to effect carrier motion in a horizontal plane, and
at least one analyzer is arranged above the track and the carriers.

2. The clinical diagnostics system of claim 1, wherein the track and the carriers are configured for real-time positioning of each carrier relative to the clinical diagnostics system.

3. The clinical diagnostics system of claim 1, further comprising a digital vision system.

4. The clinical diagnostic system of claim 3, further comprising an electronic carrier motion control system.

5. The clinical diagnostics system of claim 4, wherein the digital vision system and the electronic carrier motion control system are configured for registration and real-time positioning of an object disposed on a carrier relative to the clinical diagnostics system.

6. The clinical diagnostics system of claim 1, further comprising:
one or more loaders; and
one or more supply stations for biochemical reagents.

7. The clinical diagnostics system of claim 6, wherein at least one of the loaders and at least one of the supply stations are arranged above the track.

8. The clinical diagnostics system of claim 1, wherein the track and the carriers are configured to effect magnetic levitation and motion of the carriers in a horizontal plane above an upper surface of the track.

9. The clinical diagnostics system of claim 3, wherein the digital vision system comprises one or more digital cameras equipped with a telecentric objective.

10. The clinical diagnostics system of claim 1, wherein the at least one analyzer comprises a robotic pipettor configured for linear pipette motion in a direction substantially parallel to a vertical axis.

11. The clinical diagnostics system of claim 1, further comprising an automation control system configured for workflow optimization and sample prioritization.

12. A method for automated biochemical analysis comprising the steps of:
(a) providing a clinical diagnostics system comprising at least one analyzer and a track with a plurality of carriers, wherein the track and carriers are configured to effect carrier motion in a horizontal plane and at least one analyzer is arranged above the track and the carriers;
(b) disposing at least one container with a clinical sample on the carriers;
(c) registering the position and orientation of the at least one container relative to the clinical diagnostics system;
(d) moving each carrier to a position wherein the at least one container is arranged underneath the analyzer;
(e) transferring a clinical sample to the analyzer; and
(f) performing biochemical analysis of the clinical sample.

13. The method of claim 12, wherein, in step (c), one, two, or more digital images of the carrier and container are acquired and processed using a digital vision system.

14. The method of claim 12, wherein a workflow of biochemical analyses is optimized by an electronic automation control system.

15. The method of claim 12, wherein each carrier is magnetically levitated and moved in a horizontal plane above an upper surface of the track.

16. The method of claim 12, wherein, in step (e), a pipette is lowered along a direction that is substantially parallel to a vertical axis, immersed into the clinical sample, and a portion of the sample is aspirated and transferred to the analyzer.
